(19) United States
(12) Patent Application Publication
(10) Pub. No.: US 2024/0418573 A1
(43) Pub. Date: Dec. 19, 2024

(54) ELECTROMAGNETIC RADIATION DETECTOR

(71) Applicant: OFFICE NATIONAL D'ETUDES ET DE RECHERCHES AÉROSPATIALES, PALAISEAU (FR)

(72) Inventors: Arthur SALMON, PALAISEAU (FR); Cyprien BRULON, PALAISEAU (FR); Baptiste FIX, PALAISEAU (FR); Clément VERLHAC, PALAISEAU (FR); Patrick BOUCHON, PALAISEAU (FR)

(21) Appl. No.: 18/702,653

(22) PCT Filed: Oct. 20, 2022
(86) PCT No.: PCT/FR2022/051985

§ 371 Date: Apr. 18, 2024

(30) Foreign Application Priority Data
Nov. 23, 2021 (FR) 2112392

(51) Int. Cl. G01J 5/10; G01J 5/04; G01J 5/0875

(52) U.S. Cl. CPC G01J 5/10; G01J 5/045; G01J 5/0875

(57) ABSTRACT

An electromagnetic radiation detector (1) comprises at least one antenna (2), a portion (3) which is absorbing in a spectral band of resonance of the antenna, and means for detecting the heating produced by the absorbing portion. The antenna concentrates an electric field of electromagnetic radiation (R) to be detected within an area of concentration of the field (ZC) where the absorbing portion is located. Such detector may be functional for detecting radiation within the infrared range or the terahertz range. It may be used to create a detector for detecting image points in a two-dimensional structure so as to form an image sensor.

### TECHNICAL FIELD

This description relates to an electromagnetic radiation detector, as well as to a two-dimensional structure for detecting electromagnetic radiation.

### PRIOR ART

In this description, the terahertz range refers to all electromagnetic radiation having wavelengths between 30 μm (micrometer) and 3 mm (millimeter). Furthermore, the infrared range refers to all electromagnetic radiation having wavelengths between 1 μm and 30 μm.

Cameras which are effective in the infrared range have been known for a long time, and are used for a large number of applications. However, there is a growing need for cameras that are effective in the terahertz range, particularly in applications for seeing through walls or under degraded environmental conditions, for non-destructive testing applications, medical diagnostic applications, security applications, etc. Such terahertz-range cameras are therefore desirable, preferably while being inexpensive, light, easy to manufacture, and if possible using technologies which are already available. In particular, two-dimensional structures for detecting electromagnetic radiation which could constitute the photosensitive surfaces of such cameras are desirable.

A first category of detectors which are effective in the terahertz range is based on the generation of plasma waves in the channel of a field effect transistor (FET). This first category is not concerned by the present invention.

A second category of detectors which are effective in the terahertz range, and/or possibly also effective in the infrared range, is based on the absorption of electromagnetic radiation and on the detection of the heating which results from this absorption. Heating may be detected directly, for example using a thermochromic material as an indicator of heating, or indirectly by measuring an electrical, mechanical, or other parameter which varies according to the heating. Bolometers or microbolometers which are effective in the infrared range belong to this second category.

A third category is again based on the absorption of terahertz radiation, but it is the radiation of the thermal emission caused by heating which is then detected. Document EP 3 413 127 describes detectors of this third category.

However, the detectors of the second and third categories listed above have the following disadvantages:
their operation is limited by a compromise between detection sensitivity and response time, which depends on the thickness of the material used to absorb the radiation. A low thickness for this material allows it to heat up quickly, but only produces partial absorption of the incident radiation;
crosstalk occurs between neighboring detectors in a two-dimensional image detection structure, because of the thermal diffusion which occurs between these detectors. For this reason, the spatial resolution at which each image can be captured is limited, or multispectral images cannot be captured using neighboring detectors that are assigned to different wavelength values;
for detectors in the third category, their response time is intrinsically limited by the time required for the heat to diffuse from the portion of material which absorbs the radiation to be detected to the component that emits the thermal radiation. This limitation prevents two images from being captured rapidly one after the other, and reduces the sensitivity of each image; and
the use of thin supports, typically less than 10 μm in thickness, on which the detectors are placed in order to reduce the above disadvantages, poses mechanical problems such as the fragility of these supports, the vibrations they undergo, the need to control their tautness, difficulties in attaching them by their edges, etc.

### Technical Problem

Based on this situation, one object of the present invention is to propose a new structure for electromagnetic radiation detectors which does not present the disadvantages cited above, or in which at least some of these disadvantages are reduced.

Other objects of the invention consist of providing electromagnetic radiation detectors which occupy little space and are easy to incorporate into devices having a camera function.

### SUMMARY OF THE INVENTION

To achieve at least one of these or other objects, a first aspect of the invention proposes a novel electromagnetic radiation detector which comprises:
at least one antenna, adapted to concentrate an electric field of electromagnetic radiation which reaches this antenna, into an area of concentration of the field, when the radiation is within a spectral band of resonance of the antenna;
a portion of a material which is absorbing for the radiation within the spectral band of resonance of the antenna, called the absorbing portion, and located in the area of concentration of the field such that this absorbing portion produces heating when the radiation which is within the spectral band of resonance of the antenna reaches it; and
means for detecting the heating produced by the absorbing portion.

In the context of this invention, “antenna” designates any component adapted to modify electromagnetic radiation incident to it, when this radiation is within the spectral band of resonance of the antenna. The antenna used in the detector of the invention has the function of concentrating the electric field of the radiation within the area of concentration. Such an antenna, which can also be called an electric field concentrator, may have any configuration and composition which are adapted for producing the function of concentrating the electric field. In particular, it may be composed of one or more portion(s) of dielectric material(s) or electrical conductor(s), in particular of metal or based on semiconductor(s), possibly degenerate.

According to the invention, the absorbing portion is separate from the antenna, and the respective materials of the antenna and of the absorbing portion are such that, for radiation which reaches the antenna and is within its spectral band of resonance, a quotient of an energy absorption which occurs in the absorbing portion over a sum of an energy absorption which occurs in the antenna and the energy absorption which occurs in the absorbing portion is greater than or equal to 40%.

Thus, in the detector structure of the invention, the functions of concentration of the electric field on the one hand and absorption of the electric field on the other hand are, at least in part, carried out separately, by the antenna and by the absorbing portion respectively. This separation allows each function to be produced individually with greater efficiency, and the improved efficiency of the detector of the invention results from the combination of these two functions which is obtained by placing the absorbing portion in the area of concentration of the electric field. At least 40% of the absorption function is thus carried out by the absorbing portion, i.e. the quotient of the power of the incident electromagnetic radiation which is absorbed by the absorbing portion, over the total power which is absorbed either in this absorbing portion or in the antenna, is greater than or equal to 40%. Preferably, at least 50%, or even at least 70%, of the absorption of the radiation which reaches the antenna and is within its spectral band of resonance, occurs in the absorbing portion as opposed to the absorption contribution from the antenna.

The material of the absorbing portion may be chosen to have high absorption efficiency in the spectral band of resonance of the antenna, so that a small portion of this material is sufficient. Its heating can then be rapid, so that the detector has both high sensitivity and a short response time.

The absorbing portions of neighboring detectors on a common support may be thermally insulated from each other, in particular if the support is thermally insulating and does not contribute to an effective transmission of the heating produced by the absorption of incident radiation. In other words, neighboring detectors in accordance with the invention may exhibit weak or very weak crosstalk.

Finally, the detector of the invention may be produced on a support of any thickness, since this support need not contribute effectively to the operation of the detector. In particular, this support may have a thickness which reduces or eliminates at least some of the mechanical problems of detectors of the prior art.

Preferably, the volume of the absorbing portion may be smaller than the volume of the antenna, preferably at least five times smaller than this antenna volume. Additionally or alternatively, the largest dimension of the absorbing portion may be less than one tenth of the lower limit of the spectral band of resonance of the antenna, expressed in wavelength. In the terminology of those skilled in the art, the absorbing portion has sub-wavelength dimensions.

Preferably, the antenna does not contain any material which is identical to a material of the absorbing portion. The functions of the antenna and of the absorbing portion can thus be further separated, enabling the quotient of the power of the incident radiation which is absorbed by the absorbing portion, over the total power absorbed in this absorbing portion or in the antenna, to have higher values. The detector of the invention may thus have even greater effectiveness in detection.

In first embodiments of detectors in accordance with the invention and effective in the terahertz range, the antenna may be dimensioned so that its spectral band of resonance is contained within the wavelength range between 30 μm and 3 mm. In this case, the material of the absorbing portion may be composed of carbon nanotubes, or carbon black, or graphene.

In other embodiments of detectors in accordance with the invention and effective in the infrared range, the antenna may be dimensioned so that its spectral band of resonance is contained within the wavelength range between 1 μm and 30 μm. In these other cases, the material of the absorbing portion is absorbing in the infrared range. It may in particular be a semiconductor material with a narrow bandgap, commonly called a small-gap material.

In various embodiments of the invention, the means for detecting the heating produced by the absorbing portion may be of one of the following types:
a portion of a thermochromic material which is in thermal contact with the absorbing portion; or
an infrared radiation sensor which is arranged to detect the thermal emission radiation produced by the heating of the absorbing portion and emitted by this absorbing portion or by an additional portion of material which is in thermal contact therewith. Such an infrared radiation sensor may in particular be of the bolometric or microbolometric type, cooled or not; or
an acoustic sensor, the detector then being arranged so that the radiation produces intermittent heating of the absorbing portion, this absorbing portion being adapted to alternate in expanding and contracting in response to the intermittent heating and thus generate an acoustic wave, the acoustic sensor being arranged to detect this acoustic wave.

In the second case just cited, the additional portion of material constitutes an additional element in the composition of the detector of the invention. The function of absorbing the incident radiation, produced by the absorbing portion, and that of thermal re-emission, produced by the additional portion of material, are then carried out separately, so that their respective materials may be selected so that each function is produced with higher efficiency. In particular, they may be selected so that the emission band of the material of the additional portion is separate or disjoint from the absorption band of the material of the absorbing portion.

In first embodiments of the invention, the antenna may be composed of one or more portion(s) of a metal layer placed on an electrically insulating substrate, the thickness of the metal layer being less than one-hundredth of a central wavelength value of the spectral band of resonance of the antenna. In other words, the antenna is formed by one or more portion(s) of a thin metal layer. In this case, the electrically insulating substrate may advantageously be selected to be transparent to the thermal emission radiation produced by the heating of the absorbing portion. An infrared radiation sensor used to constitute the means for detecting the heating may thus be selectively sensitive to the radiation produced by heating the absorbing portion, relative to the thermal radiation from the substrate. This results in a higher detection sensitivity for radiation reaching the detector from the outside.

In such first embodiments of the invention, the antenna may be composed of one of the following arrangements of metal layer portions:
two disjoint metal layer segments each extending in a longitudinal direction, and each having a pointed end, both segments being opposite each other at their pointed ends and their respective longitudinal directions being superimposed. Such a first arrangement is commonly referred to as a dipole arrangement, and the area of concentration of the electric field is located between the pointed ends of the two segments;
four disjoint metal layer segments each extending in a longitudinal direction, and each having a pointed end, the four segments being distributed into two pairs, and in each pair both segments of the pair are opposite each other at their pointed ends and their respective longitudinal directions are superimposed, the longitudinal directions of the segments being perpendicular between both pairs, and a central point located between the pointed ends of segments of a same pair being identical for both pairs. Such a second arrangement is commonly referred to as a cross arrangement, and the area of concentration of the electric field is then located between the four pointed ends of the segments of the cross;
two disjoint metal layer portions each in the shape of an isosceles triangle with a main vertex and an axis of symmetry, the two portions being opposite each other at their main vertices and their respective axes of symmetry being superimposed. Such a third arrangement is commonly referred to as a bow-tie arrangement, and the area of concentration of the electric field is then located between the two main vertices of the triangles; and
at least one metal layer portion in the form of a loop, the loop being provided with at least one interrupting gap such that this loop has two edges facing each other across the interrupting gap. Such a fourth arrangement is commonly referred to as a split-ring arrangement, and the area of concentration of the electric field is then located in the split in the ring.

In second embodiments of the invention, the antenna may have one of the following structures:
a metal-insulator-metal structure, comprising a substrate which is reflecting in the spectral band of resonance of the antenna, an electrically insulating layer which is arranged on the substrate, and a metal layer portion which is located on the insulating layer, on the side facing away from the substrate. For such a first structure, the area of concentration of the electric field is located in the insulating layer, substantially under the metal layer portion or under the edges or ends thereof;
an electromagnetic Helmholtz resonator. For such a second structure, the area of concentration of the electric field is located in a slit separating two metal portions which cover a volume of dielectric material; and
a guided-mode multi-dielectric resonator, comprising: an electrically conducting substrate which is reflecting in the spectral band of resonance of the antenna, a dielectric stack which is arranged on the electrically conducting substrate, and a periodic sequence of portions of an electrically conducting layer, which is located on the dielectric stack on the side facing away from the electrically conducting substrate, the dielectric stack comprising a central dielectric layer inserted between two sandwiching dielectric layers, the central dielectric layer having a refractive index value which is greater than respective refractive index values of the sandwiching dielectric layers. For such a third structure, the area of concentration of the electric field is located near the mid-thickness level inside the central dielectric layer.

According to a first improvement of the invention, suitable when the spectral band of resonance of the antenna is within the terahertz range, the material of the absorbing portion may be composed of carbon nanotubes or carbon black, and the detector may further comprise at least one additional antenna which is dedicated to emitting infrared radiation. This additional antenna is then arranged to be coupled to the absorbing portion so as to capture and then re-emit part of the thermal emission radiation produced by the absorbing portion. It is thus possible, by suitably sizing the additional antenna, to select its resonant band to optimize the infrared radiation re-emitted, relative to the sensitivity of an infrared sensor used for the means for detecting the heating, and also relative to an absorption band of the detector's support. For this first improvement, the means for detecting the heating produced by the absorbing portion are adapted to detect the thermal emission radiation produced by the absorbing portion then re-emitted by the additional antenna. The additional antenna may also be designed to focus the thermal re-emission radiation towards the means for detecting the heating.

According to a second improvement of the invention, which is also suitable when the spectral band of resonance of the antenna is within the terahertz range, the material of the absorbing portion may be composed of carbon nanotubes or graphene, and the detector may further comprise at least one additional portion of material which is integrated into a surface of the absorbing portion, or which is in thermal contact with the absorbing portion. This additional portion of material is then adapted to produce thermal emission radiation which is generated by the heating of the absorbing portion. For this second improvement, the means for detecting the heating produced by the absorbing portion are adapted to detect the thermal emission radiation emitted by the additional portion of material.

According to a third improvement of the invention, which is again suitable for when the spectral band of resonance of the antenna is within the terahertz range, the material of the absorbing portion may be composed of carbon nanotubes or graphene, and the detector may comprise at least one additional antenna which is integrated into a surface of the absorbing portion, or which is in thermal contact with the absorbing portion. This additional antenna is then adapted to produce the thermal emission radiation generated by the heating of the absorbing portion. For this third improvement, the means for detecting the heating produced by the absorbing portion are adapted to detect the thermal emission radiation emitted by the additional antenna.

A second aspect of the invention proposes a two-dimensional structure for detecting electromagnetic radiation, which comprises several detectors each in accordance with the first aspect of the invention. In this two-dimensional structure, the antennas and the respective absorbing portions of the detectors are arranged on a surface of a support shared by the detectors. Preferably, this support is thermally insulating, to reduce or inhibit crosstalk between neighboring detectors.

In particular, the detectors may be arranged in a matrix arrangement on the surface of the support. The two-dimensional structure is then adapted to constitute the photosensitive surface of an image sensor.

Each of the detectors of the two-dimensional structure may be in accordance with one of several detector models, these detector models having selectivities which differ according to the polarization of the electromagnetic radiation, or having different spectral bands of resonance for the antenna. The detectors may then be alternated on the surface of the support according to their respective models. Such a two-dimensional structure may be adapted to capture multispectral images in particular.

Finally, the two-dimensional structure may further comprise a vacuum chamber provided with a window that is transparent to the electromagnetic radiation which reaches the antennas. The support which carries the antennas and the absorbing portions is then arranged inside the vacuum chamber.

### BRIEF DESCRIPTION OF FIGURES

The features and advantages of the invention will become more clear in the following detailed description of some non-limiting exemplary embodiments, with reference to the appended figures which include:

FIG. 1a is a cross-section of a detector according to the invention;

FIG. 1b is a plan view of the detector of FIG. 1a;

FIG. 1c corresponds to FIG. 1b for a first variant of the detector of FIG. 1a and FIG. 1b;

FIG. 1d corresponds to FIG. 1b for a second variant of the detector of FIG. 1a and FIG. 1b;

FIG. 1e corresponds to FIG. 1b for a third variant of the detector of FIG. 1a and FIG. 1b;

FIG. 1f corresponds to FIG. 1b for a fourth variant of the detector of FIG. 1a and FIG. 1b;

FIG. 2a corresponds to FIG. 1a for antennas of a different structure;

FIG. 2b also corresponds to FIG. 1a, for yet another antenna structure;

FIG. 2c similarly corresponds to FIG. 1a for yet another antenna structure;

FIG. 3a shows a detector in accordance with the invention and provided with a first type of means for detecting heating;

FIG. 3b corresponds to FIG. 3a for a second type of means for detecting heating;

FIG. 3c shows a variant arrangement for the detector of FIG. 3b;

FIG. 4a corresponds to FIG. 1c for a first improvement of the invention;

FIG. 4b corresponds to FIG. 1a for a second improvement of the invention;

FIG. 4c corresponds to FIG. 1a for a third improvement of the invention;

FIG. 5 is a plan view of a photosensitive portion of two-dimensional structure according to the invention;

FIG. 6 is a cross-section of an image sensor that incorporates the two-dimensional structure of FIG. 5;

FIG. 7 corresponds to FIG. 6 for one improvement of the invention; and

FIG. 8 corresponds to FIG. 3a for a third type of means for detecting heating.

### DETAILED DESCRIPTION OF THE INVENTION

For clarity, the dimensions of the elements represented in these figures correspond neither to actual dimensions nor to actual dimensional ratios. Furthermore, some of these elements are only represented symbolically, and identical references indicated in different figures designate elements which are identical or which have identical functions.

In all the figures, the references indicated below have the following meanings:
1 unit detector of electromagnetic radiation, in accordance with the invention,
R electromagnetic radiation to be detected, which is incident on the detector 1 and comes from an external source,
2 antenna with the function of concentrating the electromagnetic radiation R,
ZC area of concentration of the electric field, and
3 absorbing portion, located in the area of concentration ZC.

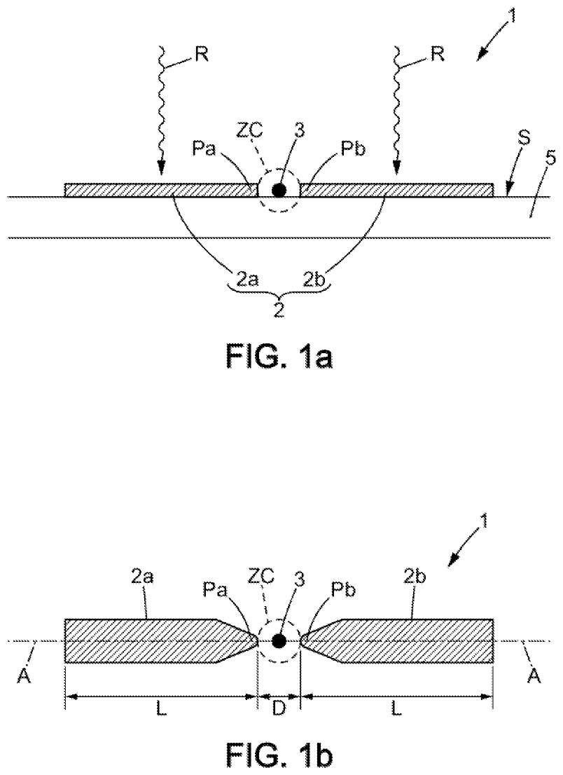

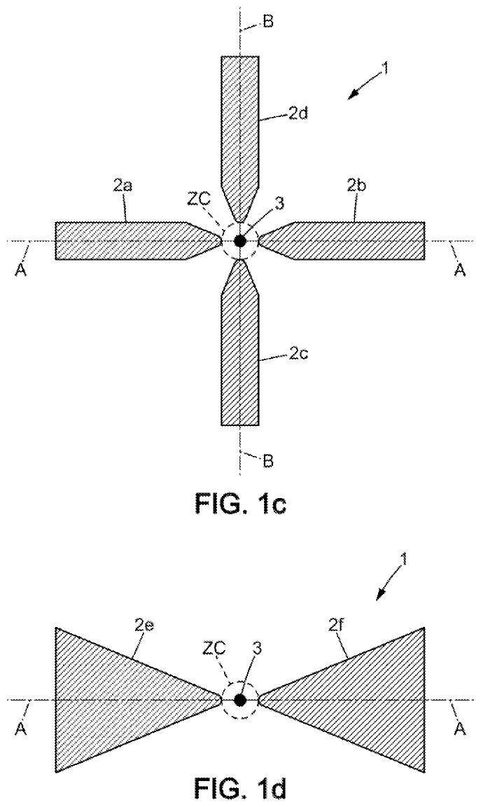

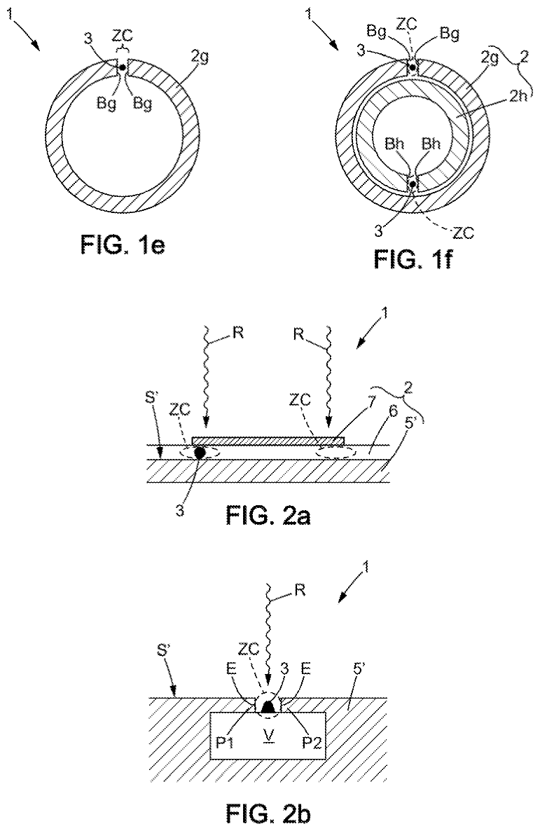

The embodiments which are described with reference to [FIG. 1a]-[FIG. 1f] may be implemented on polymer substrates, such as films of polyethylene terephthalate or PET, or polyimide films, or even aerogel substrates. Such supports, designated by the reference 5, are electrically and thermally insulating, and in the case of polymer films, they may be less than 10 μm in thickness, for example equal to approximately 3 μm. Substrates which are also transparent in the infrared range may advantageously be used when the means for detecting heating are based on one or more infrared sensor(s). Such substrates, which are both thermally insulating and transparent in the infrared range, may be made of potassium bromide (KBr), cesium iodide (CsI), or potassium chloride (KCl), for example.

The first detectors 1, now described with reference to [FIG. 1a]-[FIG. 1f], each comprise one or more metal layer portion(s) deposited on a same surface S of substrate 5. The metal layer may have a thickness of 0.1 μm for example, and be composed of gold (Au), silver (Ag), or aluminum (Al), in a non-limiting manner. Alternatively, it may be made of a degenerate semiconductor material, such as heavily doped silicon (Si) or tin-doped indium oxide (ITO). In the embodiment of [FIG. 1a] and [FIG. 1b], antenna 2 is of the dipole type and comprises two metal layer portions 2a and 2b. Each of portions 2a and 2b has the shape of a narrow and elongate segment, with one of the ends of the segment being pointed. Pa (respectively Pb) designates the end of segment 2a (resp. 2b) which is pointed, for example with a radius of curvature of approximately 20 μm. Length L of each segment 2a, 2b is to be adjusted according to the spectral band of resonance which is desired for antenna 2, in the terahertz range or in the infrared range, and according to the operating principle of a dipole antenna which is known to those skilled in the art. The two segments 2a and 2b are parallel to a same longitudinal axis A-A, their pointed ends Pa and Pb opposite each other and separated from each other by a distance D which may be equal to 100 μm. Under these conditions, the resonance wavelength of antenna 2, denoted Ares, is approximated by the empirical formula:

$${λ}_{res} = 2 \cdot L \cdot {( \frac{1 + {n}_{s}^{2}}{2} )}^{1 / 2} \cdot a + b$$

where nₛ is the refractive index of substrate 5, and a and b are two constants which depend in particular on the width of segments 2a and 2b, their thickness, and their edge shape. The area of concentration of the electric field ZC is then located between the two ends Pa and Pb of segments 2a and 2b. Antenna 2 thus produces an enhancement of the electric field of the radiation R in area ZC, with an enhancement factor which may be on the order of ten thousand.

Absorbing portion 3 may be composed of carbon nanotubes, or CNT. Alternatively, it may be composed of carbon black or graphene. It may have diameters in all directions and a thickness which are less than 40 μm, and may be arranged around a central point of the area of concentration ZC.

Antenna 2 of [FIG. 1a] and [FIG. 1b] is selective according to the direction of linear polarization of radiation R. It is possible to supplement this antenna in accordance with [FIG. 1c] to obtain a sensitivity which is independent of the direction of linear polarization of radiation R. For this, two metal layer segments 2c and 2b, which are identical to segments 2a and 2b, are added, these being parallel to axis B-B which is orthogonal to axis A-A. Antenna 2 thus obtained is invariant when rotated 90° (degree) about an axis perpendicular to surface S of substrate 5 and which passes through the center of absorbing portion 3. Antenna of [FIG. 1c] is said to be a cross-shaped model.

[FIG. 1d] illustrates yet another model of antenna 2, called a bow tie, in which the two metal layer portions 2e and 2f are each in the shape of an isosceles triangle and their main vertices are opposite each other. The two portions 2e and 2f are again separated by a gap between their main vertices, and have axis A-A as a common axis of symmetry. In this case, area of concentration ZC is located between the main vertices of the isosceles triangles.

[FIG. 1e] illustrates yet another antenna model 2, called a split ring. Antenna 2 is then composed of a metal layer portion 2g in the shape of a ring, this ring being provided with an interrupting gap located between two edges Bg of the ring which are oriented substantially radially. For this model of antenna 2, the area of concentration of the electric field ZC is located between the two edges Bg, and absorbing portion 3 is located therein. For example, such an antenna model may exhibit resonance around the wavelength value of 2 mm, when the ring has an average radius substantially equal to 160 μm, the difference between its external and internal radii is substantially equal to 50 μm, the thickness of the metal layer is equal to 1 μm, and the width of the interrupting gap is equal to 50 μm.

[FIG. 1f] illustrates a model of antenna 2 having two split rings. Antenna 2 is thus composed of two metal layer portions 2g and 2h each in the shape of a ring, these being concentric and housed one inside the other but independent. Each ring portion 2g (respectively 2h) is provided with an interrupting gap located between two edges Bg (resp. Bh) of the corresponding ring which are oriented substantially radially. The article entitled “Investigation of magnetic resonances for different split-ring resonator parameters and designs”, by Koray Aydin et al., New Journal of Physics 7, 168 (2005) presents variations in the spectral band of resonance of several antennas of this type and derived models. The model of antenna 2 of [FIG. 1f] exhibits two areas of concentration of the electric field ZC, between the two edges Bg of ring portion 2g and between the two edges Bh of ring portion 2h. Absorbing portion 3 may then be located in one or the other of these two areas of concentration of the electric field ZC.

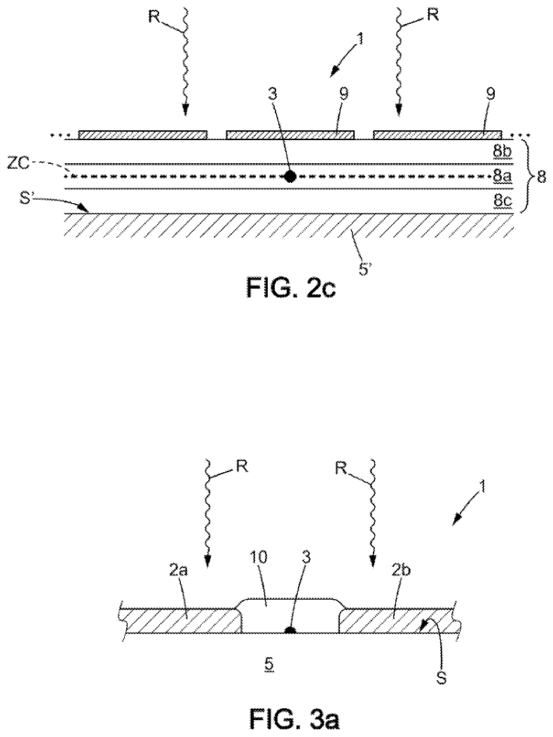

Other antenna structures may alternatively be used in a detector 1 according to the invention. For example, for a metal-insulator-metal structure such as the one represented in [FIG. 2a], the substrate may now be a metal sheet designated by the reference 5′, for example a gold sheet with a thickness approximately equal to 500 nm (nanometer). A surface S′ of substrate 5′ is covered by a layer 6 of a dielectric material, and a metal layer portion 7 is formed on layer 6, on the side facing away from substrate 5′. Metal portion 7 may have a rod shape in a plane parallel to the surface of substrate 5′, or a square, circular, or other shape. Such antennas are known to those skilled in the art and are described in particular in the article entitled “Rapid prototyping of flexible terahertz metasurfaces using a microplotter”, by A. Salmon et al., Optics Express 29, 8617 (2021). Their spectral band of resonance depends on the thickness of dielectric layer 6 and on the dimensions of metal portion 7. The area of concentration of the electric field ZC is located in dielectric layer 6, with two parts of this area which are each at one end of metal portion 7 when it has a rod shape.

Yet another structure which is possible for antenna 2 of a detector 1 according to the invention is of the electromagnetic Helmholtz resonator type, as illustrated by [FIG. 2b]. In such a structure, substrate 5′ is made of metal, for example gold, with an upper surface, preferably flat, which is also denoted S′. A volume V which is composed of an electrically insulating medium is formed below surface S′, within substrate 5′. This volume V may be filled with any gas or filled with dielectric material. For example, volume V has a large dimension perpendicular to the plane of [FIG. 2b]. It is separated from the exterior of substrate 5′ by two metal portions P1 and P2, aside from an interrupting gap between these two metal portions P1 and P2. Although metal portions P1 and P2 are shown as having continuity with substrate 5′, they may be formed by portions of a metal layer which is deposited over the dielectric material filling volume V, and over parts of substrate 5′ which laterally define volume V. Such electromagnetic Helmholtz resonators are also known to those skilled in the art, and are described in particular in the article entitled “Optical Helmholtz resonators”, by P. Chevalier et al., Applied Physics Letters 105, 071110 (2014). Structures derived from these electromagnetic Helmholtz resonators are also known, for which the volumes V of neighboring resonators are not separated by intermediate metal partitions, while retaining a similar electromagnetic operation. For all these antenna structures in accordance with the Helmholtz resonator principle, the area of concentration of the electric field ZC is located between the two respective edges E of portions P1 and P2, which are facing each other.

[FIG. 2c] illustrates yet another antenna structure which is compatible with a detector 1 according to the invention. This other structure is called a multi-dielectric waveguide, or a guided-mode multi-dielectric resonator, and is described in the article entitled “Towards perfect metallic behavior in optical resonant structures”, by Clément Verlhac et al., Optics Express 29, 18458 (2021). The waveguide cavity is formed by a volume 8 of dielectric medium which is between metal substrate 5′ and a periodic sequence of upper metal portions 9. Metal portions 9 thus form a network which is partially transparent to the radiation to be detected R, and is reflecting enough to delimit the waveguide cavity facing the reflecting surface S′ of conducting substrate 5′. The direction of propagation of the guided modes is parallel to the plane of [FIG. 2c] and to surface S′. In the structure considered, the volume 8 of dielectric medium is composed of a stack of three layers of dielectric materials. The stacking direction is perpendicular to surface S′ of substrate 5′. The central layer of the stack, designated by the reference 8a, is inserted between two sandwiching layers 8b and 8c which may be made of a same common material. Central layer 8a has a refractive index value which is greater than that of sandwiching layers 8b and 8c. For example, central layer 8a may be made of hafnium oxide (HfO₂), and sandwiching layers 8b and 8c may be made of silica (SiO₂). The use of such a structure for guide volume 8 has the effect of concentrating the electric field in an area at the center of the thickness of central layer 8a. This area of concentration ZC is indicated by a thick dotted line in [FIG. 2c]. Absorbing portion 3 is then superimposed on this area of concentration of the electric field ZC.

When detector 1 is of a type in accordance with [FIG. 1a]-[FIG. 1f], the temperature of absorbing portion 3 may increase by several tens of degrees Kelvin (K), for example by 80 K, when radiation R has a power of approximately 1 mW/mm² (milliwatt per square millimeter) and substrate 5 is a PET film that is 3 μm thick.

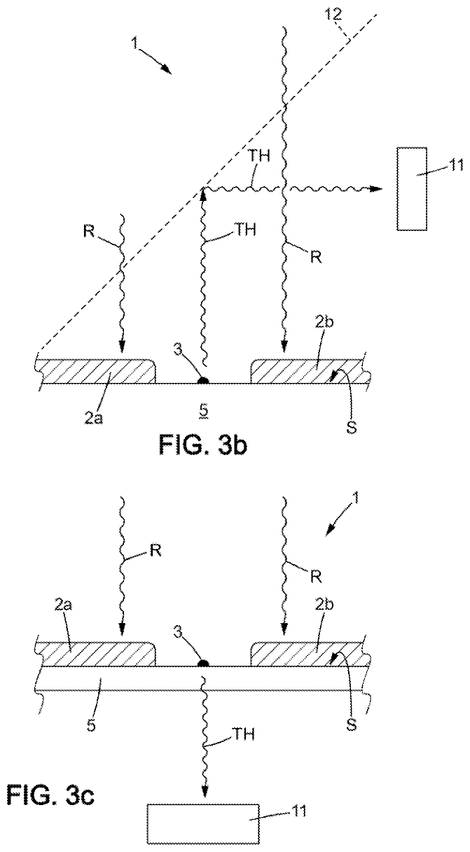

In general, absorbing portion 3 is located in the area of concentration ZC of electric field 2. For the embodiments of [FIG. 1a]-[FIG. 1f], it may be formed on the same face of substrate 5 as antenna 2. However, it may also be located on the other face of substrate 5 when the substrate is a film.

[FIG. 3a] is an enlargement of the central part of [FIG. 1a], showing one possible embodiment of the means for detecting the heating produced by absorbing portion 3 under the effect of radiation R. Although this embodiment is illustrated for detector 1 of [FIG. 1a] and [FIG. 1b], it may be combined with any structure of antenna 2. These means for detecting the heating are composed of a portion 10 of a thermochromic material which is deposited on absorbing portion 3. When absorbing portion 3 heats up, the thermochromic material of portion 10 changes color, thus revealing the radiation R incident on detector 1. This color change may be seen by an operator or captured in an image by a camera capable of distinguishing between colors within the range of variation of the thermochromic material.

Another possible embodiment of the means for detecting the heating produced by absorbing portion 3 consists of using an infrared sensor or a camera 11 which is sensitive in the thermal infrared range, as illustrated by [FIG. 3b]. The heating of absorbing portion 3 causes an increase in the radiation thermally emitted by that portion, and this thermal emission radiation, denoted TH, is detected by camera 11. [FIG. 3b] shows an arrangement of detector 1 in which the incident radiation to be detected R and the radiation TH which is re-emitted towards camera 11 are both on the same side of substrate 5. In this case, a spectral splitting device 12 may be used to separate radiations R and TH, and thus allow placing camera 11 outside the field of entry of radiation R.

For the embodiments of [FIG. 1a]-[FIG. 1f], and when the means for detecting the heating of absorbing portion 3 are based on detecting the thermal emission radiation caused by this heating, it may be advantageous that this thermal emission radiation containing the detection information be spectrally separated from the thermal emission radiation from electrically insulating substrate 5. For this purpose, the respective materials of absorbing portion 3 and of substrate 5 may have disjoint absorption bands. In other words, substrate 5 is advantageously transparent to thermal emission radiation TH coming from absorbing portion 3. In this case, a “transmission” configuration may be adopted for detector 1, as represented in [FIG. 3c], without the detection sensitivity being significantly degraded.

The three improvements which are now described facilitate obtaining the spectral separation between the radiation TH which is detected by camera 11 and the thermal emission radiation from substrate 5. More precisely, they allow spectrally concentrating radiation TH within a spectral range of transparency of the material used for substrate 5.

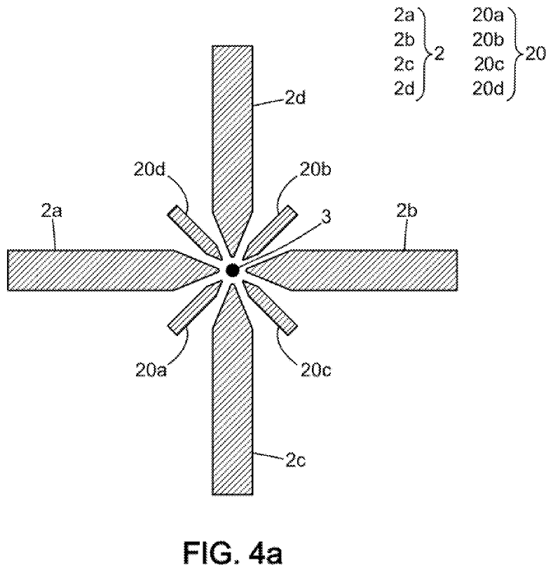

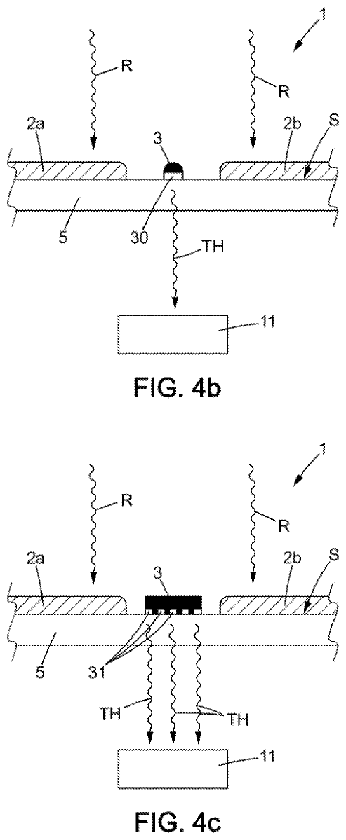

The first improvement, illustrated by [FIG. 4a], consists of using an additional antenna 20 to transmit the thermal emission radiation TH produced by the heating of absorbing portion 3. Additional antenna 20 may have an identical geometry, material, and embodiment to those of antenna 2. For example, the two antennas 2 and 20 may each have a cross shape as described with reference to [FIG. 1c], and both may be composed of respective portions of a same metal layer, for example a layer of gold. The references 20a-20d designate the metal portions of additional antenna 20, each in the form of a segment with a pointed end oriented towards absorbing portion 3. However, while antenna 2 is dimensioned so that its spectral band of resonance contains the radiation R to be detected, antenna 20 is dimensioned so that its spectral band of resonance is superimposed on both an absorption band of absorbing portion 3 and the spectral window of sensitivity of camera 11. When detector 1 is intended to detect radiation R within the terahertz range, additional antenna 20 is smaller than antenna 2, the ratio of dimensions being approximately the quotient between the central wavelength values of the respective resonance bands of antennas 20 and 2. Additional antenna 20 is preferably rotated 45° about absorbing portion 3 relative to antenna 2. When the radiation to be detected R is within the terahertz range and substrate 5 is made of PET, absorbing portion 3 may be made of carbon nanotubes or carbon black.

The second improvement, illustrated by [FIG. 4b], consists of using an additional portion of material 30 which is in thermal contact with absorbing portion 3. Thus, the heating of absorbing portion 3 that is produced by the radiation to be detected R is communicated to additional portion 30 which then emits thermal radiation TH. The material of absorbing portion 3 may then be selected so as to optimally absorb radiation R, and the material of additional portion 30 may be selected so as to optimally emit within a band of transparency of substrate 5. Thus, when the radiation to be detected R is within the terahertz range and substrate 5 is made of PET, absorbing portion 3 may be made of carbon nanotubes or graphene, and additional portion 30 may be made of carbon black or black paint.

The third improvement, which is illustrated by [FIG. 4c], consists of using infrared-emitting antennas 31 which are integrated into a surface of absorbing portion 3. Absorbing portion 3 may again be made of carbon nanotubes or graphene, and infrared-emitting antennas 31 may be of the metal-insulator-metal resonator type as recalled above, or of the electromagnetic Helmholtz resonator type, or of the Fabry-Pérot resonator type. These antennas 31 are dimensioned so that their spectral band of resonance is superimposed on the band of transparency of substrate 5 and on the spectral sensitivity window of camera 11. They directly produce the thermal emission radiation TH which is generated by the heating of absorbing portion 3.

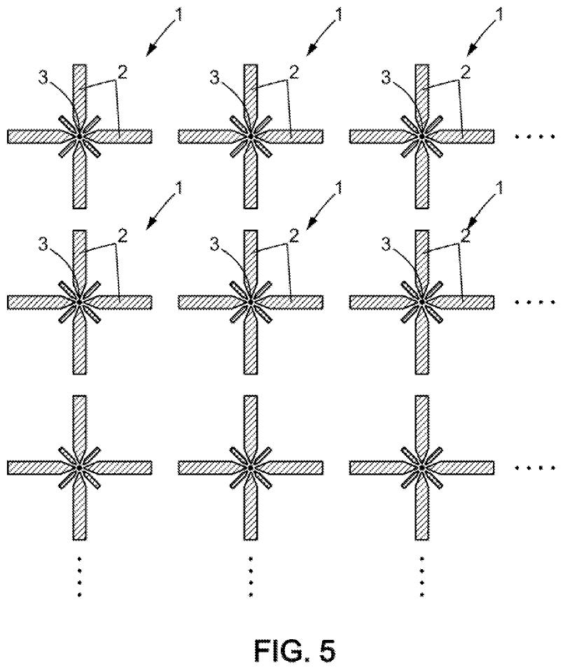

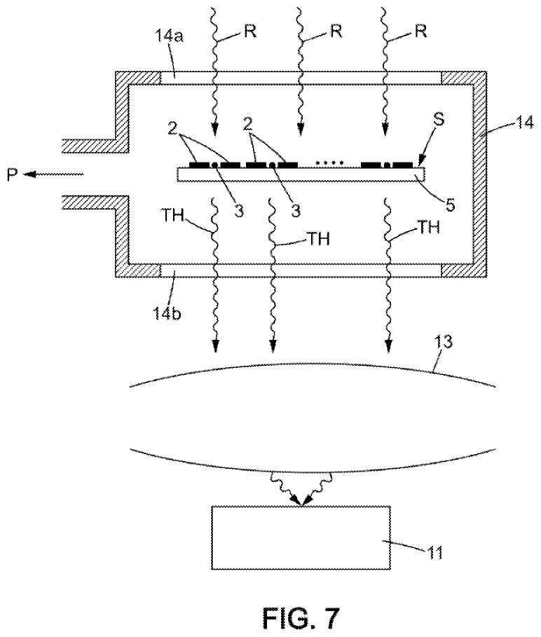

In accordance with [FIG. 5], a two-dimensional structure for detecting electromagnetic radiation may comprise the substrate provided with a plurality of antennas 2 having absorbing portions 3 dedicated to each antenna one-to-one, to form separate detectors 1 each as described above. Such a two-dimensional structure may form at least part of an image sensor that is functional in the terahertz range or in the infrared range. It may advantageously have a matrix arrangement, in order to capture images in the form of radiation intensity values respectively assigned to image points in a square pattern raster. For this purpose, antennas 2 with absorbing portions 3 are formed on the substrate in a matrix arrangement, with a distance between neighboring detectors which is adapted to reduce crosstalk due to possible heat conduction between them. The substrate is chosen so as to have sufficient thermal insulation efficiency between absorbing portions 3 of detectors 1 which are neighbors in the matrix arrangement. According to one possible improvement of the image sensor, the substrate of antennas 2 and absorbing portions 3 may be contained in a reduced pressure enclosure, commonly called a vacuum chamber, as shown in [FIG. 7] and described below.

Substrate 5 or 5′ may thus form a support which is shared by all detectors 1 of the two-dimensional structure, but an additional support shared by them all may alternatively be used.

In simple embodiments of such an image sensor, each detector 1 may be individually provided with a thermochromic portion 10 as described with reference to [FIG. 3a], and visualization of the color change of some of these thermochromic portions 10 yields the perception of each image.

Alternatively, in other embodiments of the image sensor, camera 11 may be arranged to have all absorbing portions 3 within its optical input field, and to image them simultaneously via the thermal emission radiation TH coming separately from all these absorbing portions 3. In other words, a photosensitive surface of camera 11 is optically linked to absorbing portions 3, or to the portions or antennas emitting or re-emitting infrared radiation, which are absorbing for the thermal emission radiation TH. Such arrangements may be of the “reflection” type, for example as shown in [FIG. 3b], or the “transmission” type, for example as shown in [FIG. 3c]. All of these arrangements may be combined with at least one of the improvements described for each detector 1 individually.

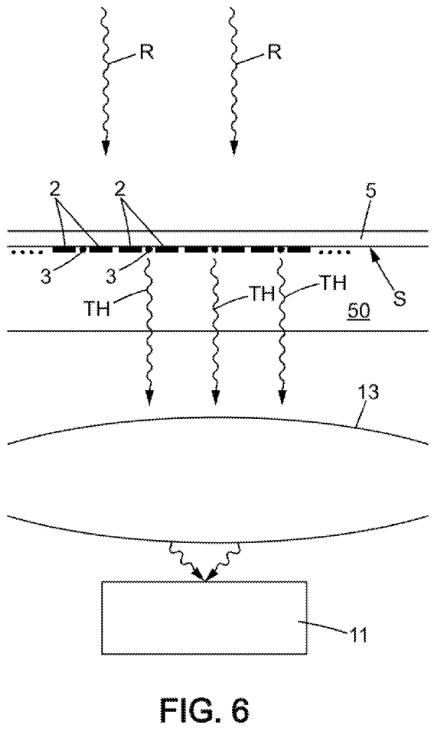

When such two-dimensional detection structure is designed to be effective within the terahertz range for the radiation to be detected R, it may be advantageous for the material of substrate 5 to be selected to be transparent in the terahertz range. In this case, an arrangement of the “transmission” type may be used, but in which surface S of substrate 5 which carries antennas 2 and absorbing portions 3 is turned towards camera 11. The terahertz radiation R to be detected then passes through substrate 5, and the thermal emission radiation TH is directly produced in the direction of camera 11. A particularly high detection sensitivity may thus be obtained. Possibly, substrate 5 oriented in this manner, between terahertz radiation R to be detected and camera 11, may be glued on an additional support 50 which is transparent to thermal emission radiation TH. This additional support 50 is then between absorbing portions 3 and camera 11. For example, such an additional support 50 may be made of potassium bromide (KBr), sodium chloride (NaCl), silicone, sapphire, etc. It may have the shape of a plate with parallel faces, or a lens which is effective in another spectral range. This last possibility may allow providing a dual-band image sensor which is simultaneously effective in this other spectral domain and in the terahertz range. The “other” spectral domain may be contained in one of the 3 μm-5 μm or 8 μm-12 μm bands. [FIG. 6] shows such a configuration with an additional support 50 which is different from substrate 5. It has the advantage of providing mechanical and chemical protection of antennas 2 and absorbing portions 3 against scratches or chemical stresses, and of preventing substrate 5 from being subjected to large-amplitude vibrations which are likely to damage it. In [FIG. 6], the reference 13 designates a relay lens which links surface S of substrate 5 with the photosensitive surface of camera 11.

With reference to [FIG. 7], a vacuum chamber 14 has the function of reducing or eliminating crosstalk contributions which could result from conducto-convective heat exchanges across a gas in contact with substrate 5. For this purpose, the interior of chamber 14 is connected to a vacuum pump, symbolically designated by the letter P. Chamber 14 is provided with an entry window 14a which is transparent to the radiation to be detected R, and with an exit window 14b which is transparent to the thermal emission radiation TH. The “transmission” configuration represented in [FIG. 7] may be adopted when substrate 5 is also transparent to the thermal emission radiation TH. For example, when the radiation to be detected R is within the terahertz range, window 14a may be made of the polymer polyethylene terephthalate, designated by the acronym PET, or of polytetrafluoroethylene, designated by PTFE, or of polyolefin based on 4-methyl-1-pentene as marketed by Mitsui Chemicals, Inc. under the name TPX®. Window 14b may be made of sapphire, silicon (Si), barium fluoride (BaF₂), calcium fluoride (CaF₂), potassium bromide (KBr), etc. For a “reflection” configuration which also uses a vacuum chamber, this may have a single window which is transparent to both radiations R and TH. When radiation R radiation is within the terahertz range, this single window may be made of sapphire or resistive silicon.

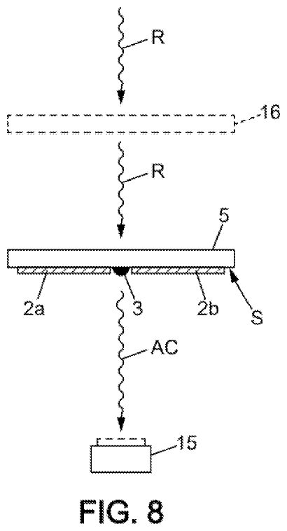

For the embodiment of the invention shown in [FIG. 8], the means for detecting the heating of absorbing portion 3 are acoustic instead of being of the thermal infrared radiation sensor type as above. For this embodiment, the material of substrate 5 is selected to be transparent to the radiation to be detected R, according to the terahertz or infrared range of the radiation. The antenna may be any of the models illustrated by [FIG. 1a]-[FIG. 1f]. Absorbing portion 3, still located in the area of concentration ZC associated with the antenna, is designed to allow its heating to be detected acoustically. For this purpose, it is made of a material optimized to absorb the radiation to be detected R and to expand under the effect of this absorption. For example, the material of absorbing portion 3 may be composite, for example formed by carbon nanotubes dispersed in a polydimethylsiloxane (PDMS) matrix. The carbon nanotubes are selected for their effectiveness in absorbing radiation R while producing heat, and the PDMS matrix is selected for the high value of its coefficient of thermal expansion. When the radiation to be detected R is pulsed, at a frequency which typically may be between 1 kHz (kilohertz) and 100 kHz, and the detector is in air, the radiation R produces a succession of expansions and contractions of absorbing portion 3, which generate an acoustic wave AC. The intensity of this acoustic wave is an increasing function of the power of the radiation R, and can be detected by an acoustic sensor 15. If the radiation to be detected R is continuous or has slow variations in intensity, the detector of the invention may further comprise a modulator 16. Such a modulator 16, which may be a motorized rotating disk with apertures or a motorized diaphragm, is placed in the path of radiation R, upstream of substrate 5. It applies an intensity modulation to the radiation R which reaches the antenna. Acoustic sensor 15 is then configured to measure an intensity of an acoustic component which is associated with the frequency value of the modulation produced by modulator 16. Such an acoustic mode of heating detection can have a response time which is particularly short.

Finally, in image sensors which use the invention, antennas 2 may be of several different models, and be alternated on surface S or S′. For example, when these models determine different spectral sensitivities, a multispectral image sensor is obtained. For example, two, three, or four models of antenna 2 may be used, which are differentiated by the antenna sizing in order to provide different spectral bands of resonance. Alternatively, models of antenna 2 may be used which have different selectivities depending on the polarization state of the radiation to be detected R. For example, two models of antenna 2 may be alternated on surface S, each in accordance with [FIG. 1a] and [FIG. 1b] but differentiated by the orientation of axis A-A: axis A-A of one of the two antenna models may be oriented perpendicularly to the other model. The image sensor is then separately sensitive to one or the other of two linear and orthogonal polarizations of radiation R.

It is understood that the invention may be reproduced by modifying secondary aspects of the embodiments described in detail above, while retaining at least some of the cited advantages. In particular, detector components which differ from those described may be used, when they produce equivalent or substantially equivalent functions. In addition, all numerical values that have been cited are for illustrative purposes only, and may be changed according to the application considered.

1. An electromagnetic radiation detector comprising:
at least one antenna, adapted to concentrate an electric field of an electromagnetic radiation which reaches said antenna, into an area of concentration of the field, when the radiation is within a spectral band of resonance of the antenna;
a portion of a material which is absorbing for the radiation within the spectral band of resonance of the antenna, called the absorbing portion, and located in the area of concentration of the field such that said absorbing portion produces heating when the radiation which is within the spectral band of resonance of the antenna reaches said antenna; and
means for detecting the heating produced by the absorbing portion,
wherein the absorbing portion is separate from the antenna, and wherein the respective materials of the antenna and of the absorbing portion are such that, for radiation which reaches the antenna and is within the spectral band of resonance of said antenna, a quotient of an energy absorption which occurs in the absorbing portion over a sum of an energy absorption which occurs in the antenna and said energy absorption which occurs in the absorbing portion is greater than or equal to 40%,
wherein the detector (1) further has one among the following three alternative combinations /1/, /2/ or /3/ of additional features:
/1/ the antenna is dimensioned so that the spectral band of resonance of said antenna is contained within a wavelength range between 30 μm and 3 mm, referred to as the terahertz range, and the material of the absorbing portion is composed of carbon nanotubes or carbon black,
the detector further comprising at least one additional antenna which is dedicated to emitting infrared radiation, said additional antenna being arranged to be coupled to the absorbing portion so as to capture and then re-emit part of a thermal emission radiation produced by said absorbing portion,
and the means for detecting the heating produced by the absorbing portion being adapted to detect the thermal emission radiation produced by the absorbing portion then re-emitted by the additional antenna; or
/2/ the antenna is dimensioned so that the spectral band of resonance of said antenna is contained within a wavelength range between 30 μm and 3 mm, referred to as the terahertz range, and the material of the absorbing portion is composed of carbon nanotubes or graphene, the detector further comprising at least one additional portion of material which is integrated into a surface of the absorbing portion, or which is in thermal contact with the absorbing portion, said additional portion of material being adapted to produce thermal emission radiation which is generated by the heating of the absorbing portion,
and the means for detecting the heating produced by the absorbing portion being adapted to detect the thermal emission radiation emitted by the additional portion of material; or
/3/ the antenna is dimensioned so that the spectral band of resonance of said antenna is contained within a wavelength range between 30 μm and 3 mm, referred to as the terahertz range, and the material of the absorbing portion is composed of carbon nanotubes or graphene, the detector further comprising at least one additional antenna which is integrated into a surface of the absorbing portion, or which is in thermal contact with the absorbing portion, said additional antenna being adapted to produce thermal emission radiation generated by the heating of the absorbing portion,
and the means for detecting the heating produced by the absorbing portion being adapted to detect the thermal emission radiation emitted by the additional antenna.

2. The detector according to claim 1, wherein a volume of the absorbing portion is smaller than a volume of the antenna, preferably at least five times smaller than the volume of the antenna, or
a largest dimension of the absorbing portion is less than one tenth of a lower limit of the spectral band of resonance of the antenna, expressed in wavelength.

3. The detector according to claim 1, wherein the antenna does not contain any material which is identical to a material of the absorbing portion.

4.-12. (canceled)

13. The detector according to claim 1, wherein the means for detecting the heating produced by the absorbing portion are of following type:
an infrared radiation sensor which is arranged to detect the thermal emission radiation produced by the heating of the absorbing portion, and emitted by said absorbing portion or by an additional portion of material which is in thermal contact with said absorbing portion.

14. The detector according to claim 1, wherein the antenna is composed of one or more portion(s) of a metal layer arranged on an electrically insulating substrate, the thickness of the metal layer being less than one-hundredth of a central wavelength value of the spectral band of resonance of the antenna.

15. The detector according to claim 14, wherein the electrically insulating substrate is selected so that said electrically insulating substrate is transparent to the thermal emission radiation produced by the heating of the absorbing portion.

16. The detector according to claim 14, wherein the antenna is composed of one of the following arrangements of metal layer portions:
two disjoint metal layer segments each extending in a longitudinal direction, and each having a pointed end, both segments being opposite each other at their pointed ends and their respective longitudinal directions being superimposed;
four disjoint metal layer segments each extending in a longitudinal direction, and each having a pointed end, the four segments being distributed into two pairs, and in each pair both segments of said pair being opposite each other at their pointed ends and their respective longitudinal directions being superimposed, the longitudinal directions of the segments being perpendicular between both pairs, and a central point which is located between the pointed ends of the segments of a same one of the pairs being identical for both pairs;
two disjoint metal layer portions each in the shape of an isosceles triangle with a main vertex and an axis of symmetry, both portions being opposite each other at their main vertices and their respective axes of symmetry being superimposed; and
at least one metal layer portion in form of a loop, the loop being provided with at least one interrupting gap such that said loop has two edges facing each other across the interrupting gap.

17. The detector according to claim 1, wherein the antenna has one of the following structures:
a metal-insulator-metal structure, comprising an electrically conducting substrate which is reflecting in the spectral band of resonance of the antenna, an electrically insulating layer which is arranged on the electrically conducting substrate, and a metal layer portion which is located on the electrically insulating layer, on a side facing away from the electrically conducting substrate;
an electromagnetic Helmholtz resonator; and
a guided-mode multi-dielectric resonator, comprising: an electrically conducting substrate which is reflecting in the spectral band of resonance of the antenna, a dielectric stack which is arranged on the electrically conducting substrate, and a periodic sequence of portions of an electrically conducting layer, which is located on the dielectric stack on a side facing away from the electrically conducting substrate, the dielectric stack comprising a central dielectric layer inserted between two sandwiching dielectric layers, the central dielectric layer having a refractive index value which is greater than the respective refractive index values of the sandwiching dielectric layers.

18. A two-dimensional structure for detecting electromagnetic radiation, comprising several detectors each in accordance with claim 1, the antennas and the respective absorbing portions of the detectors being arranged on a surface of a support shared by said detectors, preferably in a matrix arrangement on the surface of the support.

19. The two-dimensional structure according to claim 18, wherein each of the detectors is in accordance with one of several detector models, said detector models having selectivities which differ according to the polarization of the electromagnetic radiation, or having different spectral bands of resonance for the antennas, and wherein the detectors are alternated on the surface of the support according to the respective models of said detectors.

20. The two-dimensional structure according to claim 19, further comprising a vacuum chamber provided with a window that is transparent to the electromagnetic radiation which reaches the antennas, and wherein the support carrying the antennas and the absorbing portions is arranged inside the vacuum chamber.
